(19) United States
(12) Patent Application Publication
(10) Pub. No.: US 2026/0023477 A1
(43) Pub. Date: Jan. 22, 2026

(54) VIRTUAL HOME MATERIAL OBTAINING METHOD AND APPARATUS, DEVICE, AND STORAGE MEDIUM

(71) Applicant: Tencent Technology (Shenzhen) Company Limited, Shenzhen (CN)

(72) Inventor: Ziqi WEI, Shenzhen (CN)

(73) Assignee: Tencent Technology (Shenzhen) Company Limited, Shenzhen (CN)

(21) Appl. No.: 19/341,606

(22) Filed: Sep. 26, 2025

Related U.S. Application Data
(63) Continuation of application No. PCT/CN2024/116880, filed on Sep. 4, 2024.

(30) Foreign Application Priority Data
Dec. 21, 2023 (CN) 202311780417.X

(51) Int. Cl. G06F 3/04847; A63F 13/52; A63F 13/533; G06F 3/04845

(52) U.S. Cl. CPC G06F 3/04847; A63F 13/52; A63F 13/533; G06F 3/04845

(57) ABSTRACT

A virtual home material obtaining method, apparatus, and computer-readable storage medium for acquiring virtual materials through environment-based selection. The method displays a virtual environment with a range selection interface that enables users to select target ranges within the environment. User inputs indicating selected target ranges are received through the range selection interface. Virtual home materials corresponding to the target range are obtained based on virtual environment elements present within the selected range. This approach enables intuitive material acquisition by allowing users to directly select environmental areas and automatically derive appropriate virtual home materials from the elements contained within those selected regions.

### CROSS-REFERENCE TO RELATED APPLICATIONS

This application is a continuation application of International Application No. PCT/CN2024/116880 filed on Sep. 4, 2024 which claims priority to Chinese Patent Application No. 202311780417.X, filed with the China National Intellectual Property Administration on Dec. 21, 2023, the disclosures of each being incorporated by reference herein in their entireties.

### FIELD

The disclosure relates to the field of computer technologies, a virtual home material obtaining method and apparatus, a device, and a storage medium.

### BACKGROUND

With the development of computer technologies, more games support a virtual home playing method. A virtual home is a home of an interaction object in a game. In the virtual home playing method, a computer device may obtain a virtual home material, so that the interaction object can arrange the virtual home by using the virtual home material.

### SUMMARY

Provided are a virtual home material obtaining method and apparatus, a device, a storage medium, and a program product, which can implement efficient virtual home material acquisition through range-based selection and virtual environment element analysis.

According to some embodiments, a virtual home material obtaining method, performed by a computer device, includes: displaying a virtual environment; displaying a range selection interface in the virtual environment; receiving a user input indicating a target range selected from the virtual environment based on the range selection interface; obtaining a virtual home material corresponding to the target range, based on a virtual environment element in the target range.

According to some embodiments, a virtual home material obtaining apparatus, includes: at least one memory configured to store program code; and at least one processor configured to read the program code and operate as instructed by the program code, the program code including: environment code configured to cause at least one of the at least one processor to display a virtual environment; interface code configured to cause at least one of the at least one processor to display a range selection interface in the virtual environment; input code configured to cause at least one of the at least one processor to receive a user input indicating a target range selected from the virtual environment based on the range selection interface; obtaining code configured to cause at least one of the at least one processor to obtain a virtual home material corresponding to the target range, based on a virtual environment element in the target range.

According to some embodiments, a non-transitory computer-readable storage medium, storing computer code which, when executed by at least one processor, causes the at least one processor to at least: display a virtual environment; display a range selection interface in the virtual environment; receive a user input indicating a target range selected from the virtual environment based on the range selection interface; obtain a virtual home material corresponding to the target range, based on a virtual environment element in the target range.

### BRIEF DESCRIPTION OF THE DRAWINGS

FIG. 1 is a schematic diagram of an implementation environment according to some embodiments.

FIG. 2 is a flowchart of a virtual home material obtaining method according to some embodiments.

FIG. 3 is a schematic diagram of a display interface according to some embodiments.

FIG. 4 is a schematic diagram of another display interface according to some embodiments.

FIG. 5 is a schematic diagram of another display interface according to some embodiments.

FIG. 6 is a schematic diagram of another display interface according to some embodiments.

FIG. 7 is a schematic diagram of another display interface according to some embodiments.

FIG. 8 is a schematic diagram of another display interface according to some embodiments.

FIG. 9 is a schematic diagram of another display interface according to some embodiments.

FIG. 10 is a schematic diagram of another display interface according to some embodiments.

FIG. 11 is a schematic diagram of another display interface according to some embodiments.

FIG. 12 is a schematic diagram of another display interface according to some embodiments.

FIG. 13 is a schematic diagram of another display interface according to some embodiments.

FIG. 14 is a schematic diagram of another display interface according to some embodiments.

FIG. 15 is a schematic diagram of another display interface according to some embodiments.

FIG. 16 is a schematic diagram of another display interface according to some embodiments.

FIG. 17 is a schematic diagram of another display interface according to some embodiments.

FIG. 18 is a schematic diagram of a process of obtaining a virtual home material according to some embodiments.

FIG. 19 is a schematic diagram of a virtual home material obtaining apparatus according to some embodiments.

FIG. 20 is a schematic diagram of a structure of a computer device according to some embodiments.

### DESCRIPTION OF EMBODIMENTS

To make objectives, technical solutions, and advantages of this application clearer, the following further describes implementations of this application in detail with reference to the accompanying drawings.

Terms in some embodiments are described.

Virtual environment: The virtual environment is a scene provided (or displayed) when an application is run on a computer device. The virtual environment is a scene created for a virtual object to carry out an activity. The virtual environment is a two-dimensional virtual environment, a two-and-a-half-dimensional virtual environment, or a three-dimensional virtual environment. The virtual environment may be a simulated scene of the real world, a semi-simulated and semi-fictional scene, or a completely fictional scene. In some embodiments, the virtual environment may also be referred to as a virtual scene.

Virtual object: The virtual object is a movable object in a virtual environment. The virtual object may be a virtual character, a virtual animal, a cartoon character, and the like. An interaction object may control the virtual object by using a peripheral component or by tapping and touching a display screen. Each virtual object has a shape and a volume in the virtual environment, and occupies some space in the virtual environment. For example, when the virtual environment is a three-dimensional virtual environment, the virtual object is a three-dimensional model created based on a skeletal animation technology. In some embodiments, the interaction object may also be referred to as a player, a user, or the like.

Open world: The open world is a virtual environment in which a virtual object can freely roam. An interaction object may freely select a time point and a manner of completing a game task in a game supporting an open world. In some embodiments, a map corresponding to the open world may be referred to as a large map.

Home system: The home system is a social system in which an interaction object may independently arrange space in a do-it-yourself (DIY) manner. The home system may maintain a virtual home. The virtual home is a home of the interaction object is in a game. The interaction object may create a home environment with distinctive features of the interaction object by arranging the virtual home of the interaction object. The home system plays an important role in social presentation and enhancing the feeling of showing off, and is used as an important reflection of self-personalized presentation of the interaction object. The interaction object usually may pay much attention to a video of virtual home creation, and this bring a good effect on improving exposure of a game. For example, a massive multiplayer online game (MMOG), an open world game, and the like all have a home system. In other words, an MMOG, an open world game, and the like support a virtual home playing method.

In the virtual home playing method, a computer device may obtain a virtual home material, so that an interaction object can arrange a virtual home by using a virtual home material.

The virtual home material is a material used by an interaction object to arrange a virtual home. The virtual home material may be obtained from a virtual environment. For example, the virtual home material may include one or more environment elements in the virtual environment. The environment element is to an element forming a virtual environment. Types and a quantity of environment elements in a virtual environment are not limited in some embodiments, and may be set by a developer of an application supporting the virtual environment, may be set by an interaction object, or the like. For example, a type of an environment element in a virtual environment may include but is not limited to a virtual building, a virtual plant, a virtual animal, and the like.

In a related technology, a manner in which a computer device obtains a virtual home material is: using, in response to that a virtual object moves nearby a environment element in a virtual environment and obtains a material obtaining confirm operation, the environment element as the virtual home material.

In the foregoing manner, the obtained virtual home material is only limited to a environment element in the virtual environment, and has a large limitation. There may be a large difference between the environment element and a virtual home material that the interaction object expects to obtain. Consequently, intention of the interaction object to arrange a virtual home by using the virtual home material may be lowered, resulting in a low human-computer interaction rate.

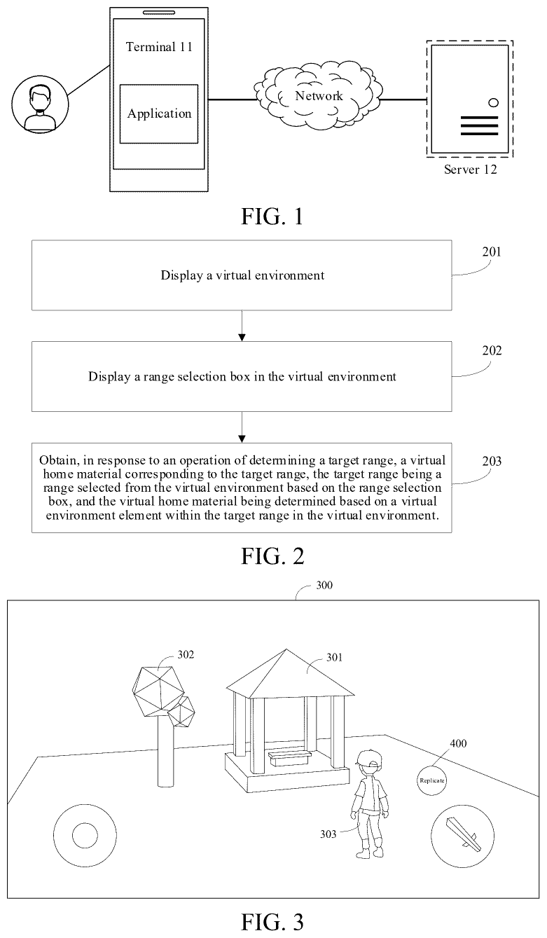

FIG. 1 is a schematic diagram of an implementation environment of a virtual home material obtaining method according to some embodiments. The implementation environment includes a terminal 11 and a server 12.

An application that supports a virtual environment is installed and run on the terminal 11. The application that supports a virtual environment supports a virtual home playing method. The method provided in some embodiments is configured for obtaining a virtual home material needed for arranging a virtual home. An interaction object can use the terminal 11 to control a virtual object to perform an activity in the virtual environment provided by the application. The activity includes but is not limited to adjusting a body posture, crawling, walking, running, riding, jumping, driving, picking up, shooting, performing competitive interaction with another virtual object, throwing, changing a position, and the like.

The application that supports a virtual environment is not limited in some embodiments. For example, the application that supports a virtual environment includes but is not limited to a virtual reality (VR) application, an augmented reality (AR) application, a three-dimensional map program, a game application, a social application, an interactive entertainment application, and the like. For example, the game application includes but is not limited to an MMOG and an open world game. In some embodiments, the application may also be referred to as a client. In other words, a client that supports a virtual environment is installed and run on the terminal 11.

In some embodiments, the application that supports a virtual environment supports at least one of a Windows operating system, an Apple's operating system, an Android operating system, an IOS operating system, and a Linux operating system. Applications run on different operating systems may be interconnected. In some embodiments, the application that supports a virtual environment is an application developed based on a three-dimensional engine. In some embodiments, the application that supports a virtual environment is a stand-alone application or a network-online application.

The server 12 is configured to provide a background service for the application that is installed on the terminal 11 and that supports a virtual environment. In a possible implementation, the server 12 undertakes main computing work and the terminal 11 undertakes secondary computing work; or the server 12 undertakes secondary computing work and the terminal 11 undertakes main computing work; or a distributed computing architecture is used between the server 12 and the terminal 11 for collaborative computing.

In a possible implementation, the terminal 11 is any electronic product that may perform human-computer interaction with the interaction object in one or more manners including a keyboard, a touch pad, a touch screen, a remote controller, a voice interaction or handwriting device, for example, a personal computer (PC), a mobile phone, a smart phone, a personal digital assistant (PDA), a wearable device, a handheld portable game device, a pocket personal computer (PPC), a tablet computer, a smart in-vehicle infotainment, a smart television, a smart speaker, or an on-board terminal. The server 12 may be one server, a server cluster including a plurality of servers, or a cloud computing service center. A communication connection is established between the terminal 11 and the server 12 via a wireless network or a wired network.

A person skilled in the art is to be understood that the terminal 11 and the server 12 are merely examples, and that other existing or possible future terminals or servers, if applicable to this application, may also fall within the protection scope of this application and are incorporated herein by reference.

Some embodiments provide a virtual home material obtaining method. The method may be applied to the implementation environment shown in FIG. 1. The method is performed by a computer device. For example, the computer device may be a terminal. In some embodiments, an example in which the method is performed by a terminal is used. For example, the method may be performed by a terminal or an application that supports a virtual environment and that is installed on the terminal. As shown in FIG. 2, the virtual home material obtaining method provided in some embodiments may include the following operation 201 to operation 203.

Operation 201: Display a virtual environment.

Some embodiments is performed by a terminal on which an application that support a virtual environment is installed. The terminal can display the virtual environment. In an exemplary embodiment, that the terminal displays the virtual environment may mean that the terminal displays, in real time, a virtual environment picture obtained by capturing, from a reference perspective, a picture of the virtual environment. The reference perspective may be set by a developer of the application, or may be set by an interaction object, which is not limited in some embodiments. In some embodiments, capturing a picture of the virtual environment from the reference perspective may also be referred to as observing the virtual environment from the reference perspective.

For example, the reference perspective may be a perspective of a first virtual object, for example, a first-person perspective of the first virtual object or a third-person perspective of the first virtual object. The first virtual object is a virtual object that performs an activity in the virtual environment and that is configured for representing the interaction object that use the terminal. If the reference perspective is a perspective of the first virtual object, in a process in which the first virtual object moves in the virtual environment, the virtual environment picture displayed on the terminal may be updated in real time.

For example, the reference perspective may further be a horizontal perspective, a top perspective, a bottom perspective, a top-view perspective, a bottom-view perspective, or the like. The horizontal perspective is a perspective observed horizontally. The top perspective is a perspective observed vertically downward. The bottom perspective is a perspective observed vertically upward. The top-view perspective is a perspective observed from top to bottom. The bottom perspective refers to a perspective observed from bottom to top.

When the virtual environment is displayed, the first virtual object in the virtual environment and another virtual object controlled by another terminal may be further displayed. The another virtual object may be in a same camp as the first virtual object, or may be in a camp different from that of the first virtual object, which is not limited in some embodiments. For example, the virtual environment is a two-dimensional virtual environment, a two-and-a-half-dimensional virtual environment, or a three-dimensional virtual environment.

In an exemplary embodiment, in addition to the virtual environment, a material obtaining control is further displayed on a display interface of the terminal. The material obtaining control is configured to control whether to enter a material obtaining mode. If the interaction object triggers the material obtaining control, the material obtaining mode is entered; or if the interaction object does not trigger the material obtaining control, the material obtaining mode is not entered, for example, an original game mode is maintained. The material obtaining mode is a mode that supports the interaction object in selecting, from the virtual environment by using a range selection box, a range corresponding to a to-be-obtained virtual home material. In some embodiments, a process of obtaining a virtual home material may also be referred to as a process of replicating a virtual environment element in the virtual environment.

A display occasion of the material obtaining control is not limited in some embodiments. For example, the material obtaining control and the virtual environment may be simultaneously displayed. In other words, when the virtual environment is displayed, the material obtaining control is displayed by default.

For example, when the first virtual object is in a non-competitive interaction state, the material obtaining control is displayed; and when the first virtual object is in a competitive interaction state, the material obtaining control is not displayed. When the first virtual object is in the competitive interaction state, the interaction object usually does not have a demand for obtaining a virtual home material. In this case, the material obtaining control is not displayed, to avoid interference caused by the material obtaining control to a competitive interaction operation performed by the interaction object, so as to improve competitive interaction experience of the interaction object, and further increase a human-computer interaction rate.

In an exemplary embodiment, the display occasion of the material obtaining control may not be limited to a position of the first virtual object in the virtual environment. In other words, the material obtaining control can be displayed regardless of a position of the first virtual object in the virtual environment, to avoid that a to-be-obtained virtual home material is limited to a virtual environment element in the virtual environment. In this way, a degree of freedom and flexibility in obtaining a virtual home material can be improved, a probability of obtaining a virtual home material that the interaction object expects to obtain can be improved, and intention of the interaction object to arrange a virtual home by using the obtained virtual home material can be improved, to increase a human-computer interaction rate.

A style of the material obtaining control is not limited in some embodiments, provided that the material obtaining control can be triggered. For example, the material obtaining control may be in a style of a button. For example, the material obtaining control may be in a style of a triggerable icon. For example, the material obtaining control may be displayed on the virtual environment picture in an overlaid manner.

For example, the display interface of the terminal may be as shown in FIG. 3. In a display interface shown in FIG. 3, a virtual environment 300 and a material obtaining control 400 are displayed. The virtual environment 300 includes a pavilion 301, a column 302, and a first virtual object 303. The pavilion 301 includes a table. The material obtaining control 400 is marked with text “replicate”. In addition to the material obtaining control 400, another interaction control may further be displayed on the display interface based on a requirement.

Operation 202: Display a range selection box in the virtual environment.

The range selection box is used by the interaction object to select, in the virtual environment, a range corresponding to a to-be-obtained virtual home material.

An occasion of displaying the range selection box in the virtual environment is not limited in some embodiments. For example, the occasion of displaying the range selection box in the virtual environment may be: directly displaying the range selection box in the virtual environment when the virtual environment is displayed. For example, the occasion of displaying the range selection box in the virtual environment may alternatively be: displaying the range selection box in the virtual environment in response to a material obtaining request. The material obtaining request is configured for indicating that the terminal may obtain a virtual home material. After obtaining the material obtaining request, the terminal displays the range selection box in the virtual environment.

In an exemplary embodiment, in a case that the material obtaining control is further displayed in addition to the virtual environment, after the virtual environment and the material obtaining control are displayed, the interaction object may determine, based on the displayed virtual environment, whether the material obtaining mode may be entered (determine whether the terminal may obtain a virtual home material), and triggers the material obtaining control after it is determined that the material obtaining mode may be entered. After the interaction object triggers the material obtaining control, the terminal obtains a trigger operation on the material obtaining control, and obtains a material obtaining request in response to the trigger operation on the material obtaining control. In other words, the range selection box is displayed in the virtual environment in response to a trigger operation on the material obtaining control. The material obtaining request may be initiated by the interaction object by triggering the material obtaining control, and the material obtaining control is intuitive. This helps increase interest of the interaction object in initiating a material obtaining request, to increase a human-computer interaction rate.

In an exemplary embodiment, the terminal may further obtain a material obtaining request in response to a material obtaining voice instruction. The material obtaining voice instruction is a voice instruction sent by the interaction object and configured for indicating that the material obtaining mode may be entered. The interaction object may determine, based on the displayed virtual environment, whether the material obtaining mode may be entered (determine whether the terminal may obtain a virtual home material), and send the material obtaining voice instruction after it is determined that the material obtaining mode may be entered, so that the terminal obtains the material obtaining request. The material obtaining request may be initiated by the interaction object by sending a voice instruction, and convenience of the interaction object in sending the voice instruction is high. This helps improve convenience of the interaction object in initiating a material obtaining request, and improve interest of the interaction object in initiating a material obtaining request, to increase a human-computer interaction rate.

In some embodiments, the terminal may further obtain the material obtaining request in another manner. For example, the terminal may obtain the material obtaining request in response to a trigger operation on a shortcut key bound with the material obtaining request. The shortcut key bound with the material obtaining request may be set by the developer of the application, or may be set by the interaction object, which is not limited in some embodiments. For example, the terminal may obtain the material obtaining request in response to that a gesture bound with the material obtaining request is recognized. The gesture bound with the material obtaining request may be set by the developer of the application, or may be set by the interaction object, which is not limited in some embodiments.

A shape of the range selection box is related to a dimension of the virtual environment. If the virtual environment is two-dimensional, the range selection box is of a two-dimensional shape. For example, the shape of the range selection box may include but is not limited to a rectangle, a square, a circle, and the like. If the virtual environment is three-dimensional, the range selection box is of a three-dimensional shape. For example, the shape of the range selection box may include but is not limited to a cuboid, a cube, a sphere, and the like.

A manner in which the terminal displays the range selection box in the virtual environment may be set based on experience, or may be flexibly adjusted based on an application scenario. For example, the terminal may display the range selection box in the virtual environment based on a facial orientation of the first virtual object and a position of the first virtual object. For example, the terminal may display the range selection box at a position in the virtual environment that is in the facial orientation of the first virtual object and that is from the position of the first virtual object by a reference distance. For example, the terminal may further enable the bottom of the range selection box to be on a lowest horizontal section (for example, a ground plane) at a current position. The reference distance may be set based on experience, or may be flexibly adjusted based on an application scenario, which is not limited in some embodiments.

A manner of representing the position of the first virtual object is not limited in some embodiments. For example, a position of any point (for example, a center of gravity or a center point on the head top) of the body of the first virtual object in the virtual environment may be used as the position of the first virtual object. For another example, a position of a midpoint of a connection line between two legs of the first virtual object in the virtual environment may be used as the position of the first virtual object. A distance to the position of the first virtual object may be a horizontal distance to the position of the first virtual object. Displaying the range selection box at the position in the virtual environment that is in the facial orientation of the first virtual object and that is from the position of the first virtual object by the reference distance may mean using the position in the virtual environment that is in the facial orientation of the first virtual object and that is from the position of the first virtual object by the reference distance as a positioning point for positioning the range selection box, and displaying the range selection box that is positioned by the positioning point. For example, the positioning point may include but is not limited to a center point, an upper left corner, a lower right corner, and the like of the range selection box.

In an exemplary embodiment, after the range selection box is displayed, the material obtaining control may be hidden, or the material obtaining control may be retained, which is not limited in some embodiments.

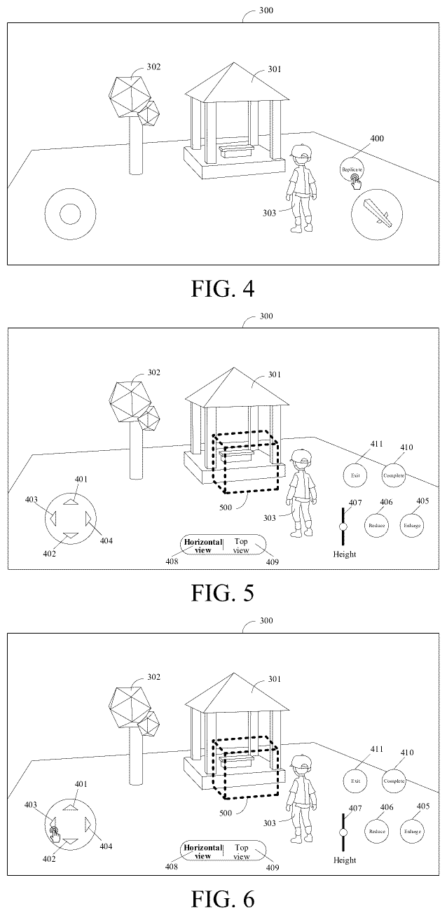

For example, as shown in FIG. 4, after the material obtaining control 400 is displayed, the interaction object may trigger the material obtaining control 400. After the terminal obtains a trigger operation of the material obtaining control 400, a display interface shown in FIG. 5 is displayed. In the display interface shown in FIG. 5, a range selection box 500 is displayed at a position in a facial orientation of the first virtual object, and the material obtaining control 400 is hidden.

In an exemplary embodiment, after the range selection box is displayed, a range covered by the range selection box may not be a range expected by the interaction object. In this case, the terminal may further adjust the range selection box based on an operation of the interaction object, so that a range covered by an adjusted range selection box is a range expected by the interaction object.

An adjustment manner supported by the range selection box is not limited in some embodiments, and may be set based on experience, or may be flexibly adjusted based on an application scenario.

In an exemplary embodiment, the adjustment manner supported by the range selection box may include performing adjustment by using an adjustment control. In this case, the range selection box corresponds to an adjustment control, and a process of adjusting the range selection box includes: adjusting, in response to a trigger operation on the adjustment control, the range selection box based on an adjustment manner corresponding to the adjustment control. In this manner, the interaction object can randomly adjust the range selection box based on the adjustment control, and flexibility in adjusting the range selection box is high. This helps improve flexibility in obtaining a virtual home material, improve a probability of obtaining a virtual home material that the interaction object expects to obtain, and improve intention of the interaction object to arrange a virtual home by using the obtained virtual home material, to increase a human-computer interaction rate.

The adjustment control is a control configured to adjust the range selection box, and a type of the adjustment control may be set by the developer. In an exemplary embodiment, the adjustment control includes at least one of a translation control, a rotation control, or a size adjustment control.

The translation control is configured to translate the range selection box. For example, the translation control includes at least one of an upward translation control, a downward translation control, a leftward translation control, a rightward translation control, a forward translation control, and a backward translation control. The upward translation control is configured to translate the range selection box upward. The downward translation control is configured to translate the range selection box downward. The leftward translation control is configured to translate the range selection box leftward. The rightward translation control is configured to translate the range selection box rightward. The forward translation control is configured to translate the range selection box forward. The backward translation control is configured to translate the range selection box backward.

In an example in which the virtual environment is a three-dimensional virtual environment, a space coordinate system including an x axis, a y axis, and a z axis may be established in the virtual environment. Upward translation and downward translation mean translation in a longitudinal direction (for example, a direction of the z axis). Leftward translation and rightward translation mean translation in a horizontal direction (for example, a direction of the x axis) in a two-dimensional plane (for example, a plane formed by the x axis and the y axis). Forward translation and backward translation mean translation in another horizontal direction (for example, a direction of the y axis) in the two-dimensional plane (for example, the plane formed by the x axis and the y axis).

For example, the translation control may be in a form of a button or an icon, an arrow may be displayed on the button or the icon, and a direction pointed by the arrow is a direction for controlling the range selection box to translate. For example, the upward translation control may be in a form of a button or an icon displayed with an arrow pointing to the top; the downward translation control may be in a form of a button or an icon displayed with an arrow pointing to the bottom; the leftward translation control may be in a form of a button or an icon displayed with an arrow pointing to the left; the rightward translation control may be in a form of a button or an icon displayed with an arrow pointing to the right; the forward translation control may be in a form of a button or an icon displayed with an arrow pointing to the front; and the backward translation control may be in a form of a button or an icon displayed with an arrow pointing to the back. For example, up and down may be two directions in a longitudinal direction; left and right may be two directions in a horizontal direction in a two-dimensional plane; and front and rear may be two directions in another horizontal direction in the two-dimensional plane.

The rotation control is configured to rotate the range selection box. For example, the rotation control may be in a form of a wheel. A pointer in the wheel may point to any angle of 360 degrees, and an angle by which the range selection box is rotated may be controlled by controlling an angle to which the pointer in the wheel points.

In some embodiments, the rotation control may further be in another form. For example, the rotation control may be in a form of a rotatable icon. The interaction object may press a finger on the rotatable icon for rotation, and an angle by which the range selection box is rotated is controlled by an angle by which the finger rotates. For another example, the rotation control may be in a form of a bar with a scale. The scale on the bar is configured for indicating an angle, and an angle by which the range selection box is rotated may be controlled by using an angle indicated by the scale selected by the interaction object.

The size adjustment control is configured to adjust a size of the range selection box. For example, the size adjustment control includes at least one of an overall-enlargement control, an overall-reduction control, or a dimension adjustment control. The overall-enlargement control is configured to proportionally scale up all dimensions of the range selection box. The overall-reduction control is configured to proportionally scale down all dimensions of the range selection box. The dimension adjustment control includes a sub-control corresponding to at least one dimension. A sub-control corresponding to any dimension is configured to adjust a size of the any dimension of the range selection box. The at least one dimension means a part or all of dimensions that determine an overall size of the range selection box. The dimensions that determine the overall size of the range selection box are related to the shape of the range selection box. For example, if the range selection box is a cuboid, the dimensions that determine the overall size of the range selection box each include length, width, and height; if the range selection box is a cube, the dimensions that determine the overall size of the range selection box each include side length; or if the range selection box is a sphere, the dimensions that determine the overall size of the range selection box each include radius. A case of the at least one dimension (a case of the sub-control included in the dimension adjustment control) may be flexibly set based on the shape of the range selection box, a type of the application, and the like, which is not limited in some embodiments.

For example, the shape of the range selection box is a cuboid, and a plane of the range selection box is parallel to the ground plane of the virtual environment. In this case, the at least one dimension may include at least one of height, length, or width. The dimension adjustment control may include at least one of a sub-control corresponding to the height, a sub-control corresponding to the length, or a sub-control corresponding to the width. The sub-control corresponding to the height is configured to keep a length size and a width size of the range selection box unchanged, and adjust (enlarge or reduce) a height size of the range selection box. The sub-control corresponding to the length is configured to keep the height size and the width size of the range selection box unchanged, and adjust (enlarge or reduce) the length size of the range selection box. The sub-control corresponding to the width is configured to keep the length size and the height size of the range selection box unchanged, and adjust (enlarge or reduce) the width size of the range selection box.

For example, in a case that the dimension adjustment control includes the sub-control corresponding to the height, using a lowest horizontal plane in the virtual environment as a reference, increasing the height size of the range selection box means increasing the height size of the range selection box above the lowest horizontal plane, so that the range selection box does not pass through the lowest horizontal plane.

It is clear that, in a case that the shape of the range selection box is another shape, the sub-control included in the dimension adjustment control may alternatively have another case. For example, in a case that the shape of the range selection box is a cube, the dimension adjustment control includes a sub-control corresponding to the side length. For another example, if the shape of the range selection box is spherical, the dimension adjustment control includes a sub-control corresponding to the radius.

Forms of the overall-enlargement control, the overall-reduction control, and the dimension adjustment control may be set based on experience, or may be flexibly adjusted based on an application scenario, which is not limited in some embodiments. For example, the overall-enlargement control may be in a form of an icon or a button for displaying information configured for prompting enlargement. For example, the information configured for prompting enlargement may be a word “enlarge” or a plus sign “+”. The overall-reduction control may be in a form of an icon or a button displaying information configured for prompting reduction. For example, the information configured for reduction may be a word “reduce” or a minus sign “−”. The sub-control corresponding to the any dimension in the dimension adjustment control may be displayed by using a progress bar. The progress bar has a progress mark. The progress mark is at a middle position of the progress bar by default. The progress mark is moved in the progress bar from the middle position of the progress bar, so that the size of the dimension of the range selection box can be adjusted. In an example in which the progress bar is vertically placed, the progress mark is moved upward in the progress bar from the middle position of the progress bar, so that the size of the dimension of the range selection box is enlarged; and the progress mark is moved downward in the progress bar from the middle position of the progress bar, so that the size of the dimension of the range selection box is reduced.

A process of adjusting the range selection box in an adjustment manner corresponding to the adjustment control is related to a type of the adjustment control. For example, if the adjustment control is a translation control, the adjusting the range selection box in an adjustment manner corresponding to the adjustment control means translating the range selection box based on a translation direction corresponding to the translation control. If the adjustment control is a rotation control, the adjusting the range selection box in an adjustment manner corresponding to the adjustment control means rotating the range selection box by a rotation angle corresponding to the rotation control. If the adjustment control is a size adjustment control, the adjusting the range selection box in an adjustment manner corresponding to the adjustment control means adjusting the size of the range selection box based on a to-be-adjusted dimension indicated by the size adjustment control and in a size adjustment manner corresponding to the to-be-adjusted dimension.

For example, a process of translating the range selection box based on the translation direction corresponding to the translation control includes: determining, based on the translation direction corresponding to the translation control, a translation distance corresponding to the translation direction, and translating the range selection box toward the translation direction by the translation distance. The translation distance corresponding to the translation direction may be determined based on a correspondence between a direction and a distance. Different translation distances may correspond to the same translation direction or different translation directions.

For example, the size adjustment manner corresponding to the to-be-adjusted dimension may include but is not limited to enlarging a size corresponding to the to-be-adjusted dimension by a first reference quantity of multiples or reducing the size corresponding to the to-be-adjusted dimension by a second reference quantity of multiples. The first reference quantity and the second reference quantity may be set based on experience, or may be determined based on a manner of triggering the size adjustment control by the interaction object, which is not limited in some embodiments.

A plurality of adjustment controls are configured, so that ways of adjusting the range selection box for the interaction object can be enriched, flexibility in adjusting the range selection box by the interaction object can be further improved, and interest of the interaction object in selecting a target range by adjusting the range selection box can be improved, to increase a human-computer interaction rate.

For example, referring to FIG. 5, adjustment controls corresponding to a range selection box 500 include a translation control and a size adjustment control. The translation control includes an upward translation control 401, a downward translation control 402, a leftward translation control 403, and a rightward adjustment control 404. The size adjustment control includes an overall-enlargement control 405, an overall-reduction control 406, and a dimension adjustment control 407. The dimension adjustment control 407 is a sub-control corresponding to height. The dimension adjustment control 407 is configured to adjust a height of the range selection box.

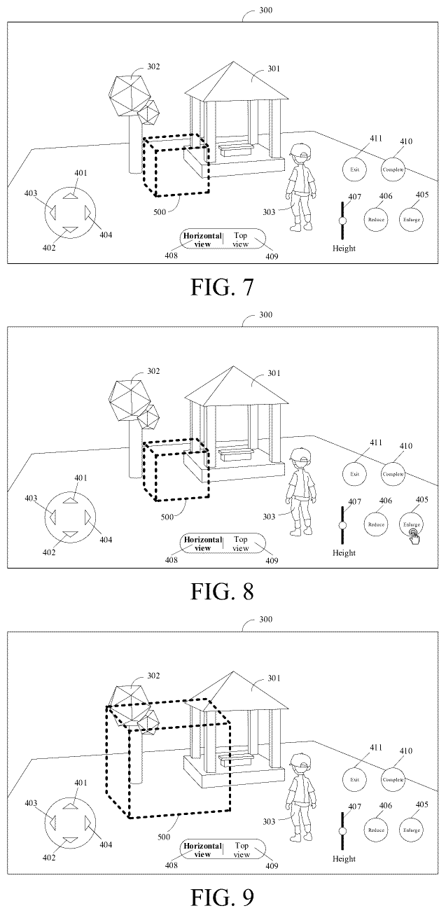

If the interaction object triggers the leftward translation control 403 (as shown in FIG. 6), the terminal obtains a trigger operation on the leftward translation control 403, and the range selection box 500 is translated leftward. A display interface after the range selection box 500 is translated leftward is shown in FIG. 7. After the leftward translation control 403 is triggered, if the interaction object triggers the overall-enlargement control 405 (as shown in FIG. 8), the terminal obtains a trigger operation on the overall-enlargement control 405, and the range selection box 500 is enlarged as a whole. A display interface after the range selection box 500 is enlarged as a whole is shown in FIG. 9.

In an exemplary embodiment, the adjustment manner supported by the range selection box may include performing adjustment based on a target element selected from the virtual environment. In this case, a process of adjusting the range selection box includes: moving, in response to a selection operation on the target element in the virtual environment, the range selection box to a position with a center of the target element as a center, and adjusting the size of the range selection box to a size that encloses the target element. In this manner, the interaction object can quickly adjust the range selection box based on the target element, which is highly convenient. This helps improve efficiency of selecting the target range, and further improves efficiency of obtaining a virtual home material.

The target element is configured for positioning an adjusted position and an adjusted size of the range selection box. For example, the target element is any element in the virtual environment. For example, the target element is an element in the virtual environment that satisfies a reference condition. Satisfying the reference condition may be set based on experience, or may be flexibly adjusted based on an application scenario, which is not limited in some embodiments. In an exemplary embodiment, the element satisfying the reference condition may be an element that is in the virtual environment and whose size is larger than a reference size. The reference size is set based on experience or flexibly adjusted based on an empirical scenario. In an exemplary embodiment, the element satisfying the reference condition may be an element in the virtual environment and configured with a reference mark. For example, the reference mark may be configured for an element that is in the virtual environment and that supports being independently used as a virtual home material. The element supporting being separately used as a virtual home material may be set based on experience, or may be flexibly adjusted based on a type of an application. For example, all or a part of independent items in the virtual environment may be used as elements supporting being separately used as virtual home materials. The reference mark may be a mark of any type. For example, the reference mark may be a letter (for example, A) or a number (for example, 1).

For example, the selection operation on the target element may be a trigger operation on the target element, for example, click/tap or double-click/double-tap. For example, the selection operation on the target element may alternatively be a trigger operation or the like on a sub-menu that is in an operation menu of the target element and that is configured for indicating to select the target element.

After the selection operation on the target element in the virtual environment is obtained, the range selection box is adjusted based on the target element. A process of adjusting the range selection box based on the target element relates to adjustment on both the position and the size of the range selection box. A manner of adjusting the position of the range selection box is: moving the range selection box to the position with the center of the target element as the center. In other words, a center of the range selection box obtained after the movement coincides with the center of the target element. A manner of adjusting the size of the range selection box is: adjusting the size of the range selection box to a size that encloses the target element.

After the size of the range selection box is adjusted to the size that encloses the target element, the target element is completely in the range selection box. For example, in a process of adjusting the size of the range selection box to the size that encloses the target element, the shape of the range selection box may be kept unchanged, or the shape of the range selection box may be adaptively changed based on a shape of the target element. For example, adjusting the size of the range selection box to the size that encloses the target element may be adjusting the size of the range selection box to a minimum size in sizes that encloses the target element.

In some embodiments, a sequence of adjusting the position of the range selection box and adjusting the size of the range selection box after the selection operation of the target element is obtained is not limited. For example, the position of the range selection box may be adjusted first, and then the size of the range selection box is adjusted. The range selection box is moved to the position with the center of the target element as the center, and then the size of the range selection box is adjusted to the size that encloses the target element. For example, the size of the range selection box may be first adjusted, and then the position of the range selection box is adjusted. The size of the range selection box is first adjusted to the size that encloses the target element, and then the range selection box is moved to the position with the center of the target element as the center. It is clear that, in some embodiments, the position of the range selection box and the size of the range selection box may alternatively be adjusted simultaneously. In a process of adjusting the position of the range selection box, the size of the range selection box is adjusted.

In some embodiments, an example in which the center of the range selection box does not coincide with the center of the target element and the size of the range selection box is not the size that completely encloses the target element when the selection operation on the target element is obtained is merely used for description, and some embodiments are not limited thereto.

If the center of the range selection box coincides with the center of the target element and the size of the range selection box is not the size that completely encloses the target element when the selection operation on the target element is obtained, only the operation of adjusting the size of the range selection box to the size that encloses the target element is performed. If the center of the range selection box does not coincide with the center of the target element and the size of the range selection box is the size that completely encloses the target element when the selection operation on the target element is obtained, only the operation of moving the range selection box to the position with the center of the target element as the center is performed. If the center of the range selection box coincides with the center of the target element and the size of the range selection box is the size that completely encloses the target element when the selection operation on the target element is obtained, no operation of adjusting the range selection box is performed.

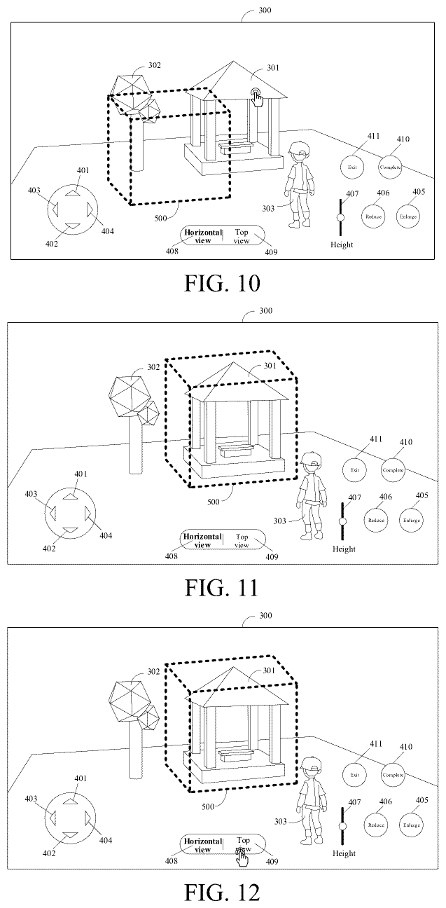

For example, if the target element selected by the interaction object in the virtual environment 300 is the pavilion 301 (as shown in FIG. 10), the terminal obtains a selection operation on the pavilion 301, moves the range selection box 500 to a position using a center of the pavilion 301 as a center, and adjusts a size of the range selection box 500 to a size that encloses the pavilion 301, to obtain a display interface shown in FIG. 11.

In an exemplary embodiment, the adjustment manner supported by the range selection box may include performing adjustment based on a voice adjustment instruction. In this case, a process of adjusting the range selection box includes: obtaining a voice adjustment instruction of the interaction object, parsing the voice adjustment instruction, determining an adjustment manner corresponding to the voice adjustment instruction, and adjusting the range selection box in the adjustment manner corresponding to the voice adjustment instruction. If the terminal has a function of parsing voice of the interaction object, the adjustment manner in which the interaction object controls the range selection box by using a voice instruction is supported. Content of the voice adjustment instruction may be determined by the interaction object, which is not limited in some embodiments.

In an exemplary embodiment, the adjustment manner supported by the range selection box may include performing adjustment based on a drag operation. In this case, a process of adjusting the range selection box includes: obtaining a drag operation of the interaction object on the range selection box, and adjusting the range selection box based on an adjustment manner indicated by the drag operation. The adjustment manner indicated by the drag operation may be translating the range selection box toward a direction, enlarging or reducing the size of the range selection box in a direction, or the like, which is not limited in some embodiments.

The foregoing adjustment manner supported by the range selection box is merely an exemplary example, and some embodiments are not limited thereto. In some embodiments, the adjustment manner supported by the range selection box may further include another manner. In some embodiments, the range selection box may simultaneously support a plurality of adjustment manners. For example, the range selection box may simultaneously support at least two of the following adjustment manners: performing adjustment by using the adjustment control, performing adjustment based on the target element selected from the virtual environment, performing adjustment based on the voice instruction, or performing adjustment based on the drag operation. For a case in which the range selection box supports a plurality of adjustment manners, the plurality of adjustment manners may be combined, in other words, the range selection box may be adjusted a plurality of times in the plurality of adjustment manners.

In an exemplary embodiment, a default display effect of the virtual environment and the range selection box on the display interface may be a display effect in a first perspective. After displaying the range selection box, the terminal may further switch, in response to a switching operation of switching the first perspective to a second perspective, the display effect of the virtual environment and the range selection box in the first perspective to a display effect in the second perspective. A perspective switching function is provided, so that the interaction object can adjust the range selection box more accurately through observation from a plurality of perspectives. In this way, accuracy of a target range can be improved, and a degree of matching between an obtained virtual home material and an expectation of the interaction object can be further improved, to increase a human-computer interaction rate.

The first perspective is a perspective used by default for displaying the virtual environment and the range selection box. The second perspective is a perspective after switching. The first perspective and the second perspective are different perspectives for observing the virtual environment. The first perspective the second perspective may be flexibility set based on experience, or may be flexibly adjusted based on an application scenario, which is not limited in some embodiments. For example, the first perspective may be a horizontal perspective, and the second perspective may be a top perspective.

In an exemplary embodiment, the display interface of the terminal may display a perspective selection menu. The perspective selection menu includes at least the first perspective and the second perspective. By default, the first perspective in the perspective selection menu is in a selected state. If the interaction object selects the second perspective, the terminal obtains a switching operation of switching the first perspective to the second perspective, and sets the second perspective in the perspective selection menu to a selected state.

In an exemplary embodiment, the display interface of the terminal displays at least a control corresponding to the first perspective and a control corresponding to the second perspective. When the virtual environment and the range selection box are displayed by using the first perspective, the control corresponding to the first perspective is in a non-triggerable state, and the control corresponding to the second perspective is in a triggerable state. If a trigger operation on the control corresponding to the second perspective is obtained, a switching operation of switching the first perspective to the second perspective is obtained. After the switching operation of switching the first perspective to the second perspective is obtained, the control corresponding to the second perspective is adjusted to a non-triggerable state, and the control corresponding to the first perspective is adjusted to a triggerable state. In some embodiments, a control corresponding to another perspective different from the first perspective and the second perspective may further be displayed on the display interface for the interaction object to select, which is not limited in some embodiments.

For example, the first perspective is a horizontal perspective, and the second perspective is a top perspective. Refer to FIG. 5 to FIG. 11. A control 408 corresponding to the horizontal perspective and a control 409 corresponding to the top perspective are displayed on the display interface. The control 408 corresponding to the horizontal perspective is in a non-triggerable state, and the control 409 corresponding to the top perspective is in a triggerable state. Display effects of the virtual environment 300 and the range selection box 500 on the display interfaces shown in FIG. 5 to FIG. 11 are all display effects in a horizontal perspective.

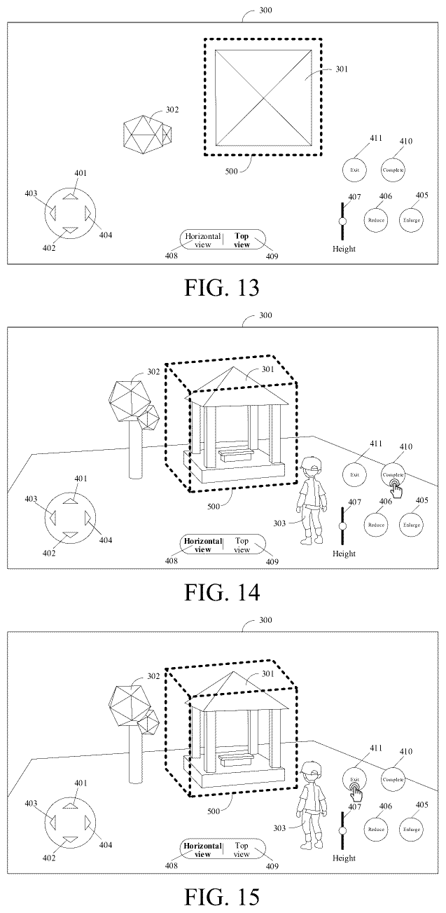

If the interaction object triggers the control 409 (refer to FIG. 12) corresponding to the top perspective, the terminal obtains a switching operation of switching the horizontal perspective to the top perspective, and switches a display effect of the virtual environment 300 and the range selection box 500 from a display effect in the horizontal perspective to a display effect in the top perspective. A display interface after the display effect is switched is shown in FIG. 13. In FIG. 13, the control 408 corresponding to the horizontal perspective is in a triggerable state, and the control 409 corresponding to the top perspective is in a non-triggerable state.

Operation 203: Obtain, in response to an operation of determining a target range, a virtual home material corresponding to the target range, the target range being a range selected from the virtual environment based on the range selection box, and the virtual home material being determined based on a virtual environment element within the target range in the virtual environment.

After displaying the range selection box, if the terminal obtains the operation of determining the target range, the terminal uses the target range as a range needed for obtaining a virtual home material, to obtain the virtual home material corresponding to the target range.

The target range is a range selected from the virtual environment based on the range selection box. For example, the target range may be a range in the virtual environment that is covered by an initially displayed range selection box, or may be a range in the virtual environment that is covered by a range selection box obtained after adjusting an initially displayed range selection box, which is not limited in some embodiments.

In an exemplary embodiment, the range selection box corresponds to a confirm control. In response to a trigger operation on the confirm control, a range in the virtual environment that is covered by the range selection box when the trigger operation on the confirm control is obtained is used as a target range, to obtain an operation of determining the target range.

For example, as shown in FIG. 5 to FIG. 13, a confirm control 410 corresponding to the range selection box 500 is displayed on the display interface. When it is determined that a range covered by the range selection box 500 is an expected range, the interaction object may trigger the confirm control 410 (as shown in FIG. 14). After the interaction object triggers the confirm control 410, the terminal obtains an operation of determining the target range.

In an exemplary embodiment, a manner of obtaining the operation of determining the target range may alternatively be: using, in response to that the range in the virtual environment that is covered by the range selection box does not change within reference duration, the range in the virtual environment that is covered by the range selection box as the target range, to obtain the operation of determining the target range. The reference duration may be set based on experience, or may be flexibly adjusted based on an application scenario, which is not limited in some embodiments. For example, the reference duration may be one minute, or may be 30 seconds.

In an exemplary embodiment, a manner of obtaining the operation of determining the target range may alternatively be: using, as the target range in response to a trigger operation on a target shortcut key, a range in the virtual environment that is covered by the range selection box when the trigger operation on the target shortcut key is obtained, to obtain the operation of determining the target range. The target shortcut key is a shortcut key bound with the operation of determining the target range. The target shortcut key may be set by the developer of the application, or may be set by the interaction object, which is not limited in some embodiments.

In an exemplary embodiment, a manner of obtaining the operation of determining the target range may alternatively be: using, as the target range in response to that a target gesture is recognized, a range in the virtual environment that is covered by the range selection box when the target gesture is recognized, to obtain the operation of determining the target range. The target gesture is a gesture bound with the operation of determining the target range. The target gesture may be set by the developer of the application, or may be set by the interaction object, which is not limited in some embodiments.

After the operation of determining the target range is obtained, the virtual home material corresponding to the target range is obtained. The virtual home material is determined based on the virtual environment element within the target range in the virtual environment. Because the target range is a range selected from the virtual environment based on the range selection box, and is a range satisfying an expectation of the interaction object, a degree of matching between the virtual home material determined based on the virtual environment element within the target range and a material requirement of the interaction object is high. This helps improve reliability of obtaining a virtual home material, and increase a human-computer interaction rate.

In an exemplary embodiment, there are two cases for the virtual environment element: The virtual environment element satisfies a division condition and the virtual environment element does not satisfy a division condition. In different cases of the virtual environment element, cases for the virtual home material vary. For example, in a case that the virtual environment element satisfies the division condition, the virtual home material includes the virtual environment element and a sub-level environment element. In a case that the virtual environment element does not satisfy the division condition, the virtual home material includes the virtual environment element, and the virtual home material does not include another environment element. The sub-level environment element is obtained by dividing the virtual environment element.

A process of determining the virtual home material based on the virtual environment element includes: determining whether the virtual environment element satisfies the division condition; and dividing the virtual environment element if the virtual environment element satisfies the division condition, to obtain a sub-level environment element, and using the virtual environment element and the sub-level environment element as obtained virtual home materials, in this case, the virtual home material being a material group including a plurality of elements; or skipping diving the virtual environment element if the virtual home material does not satisfy the division condition, and directly using the virtual environment element as an obtained virtual home material.

In some embodiments, a function of automatically dividing the virtual environment element is provided, so that the virtual environment element satisfying the division condition can be automatically divided. In addition, the entire virtual environment element and a sub-level environment element obtained through division are both used as virtual home materials, so that the interaction object can arrange a virtual home by using both the entire virtual environment element and the sub-level environment element obtained through division, to provide more material selection solutions for arranging a virtual home. This helps improve an arrangement effect of a virtual home, and increase a human-computer interaction rate.

Satisfying the division condition may be set based on experience, or may be flexibly adjusted based on an application scenario, which is not limited in some embodiments. In an exemplary embodiment, that the virtual environment element satisfies the division condition may mean that the virtual environment element include an element configured with a reference mark. The element configured with the reference mark may be preconfigured by the developer, which is not limited in some embodiments. For example, reference marks are configured for all independent items in the virtual environment. For example, a reference mark is configured for an independent item whose size is not smaller than the reference size in the virtual environment. The reference mark may be a mark of any type. For example, the reference mark may be a letter (for example, A) or a number (for example, 1).

In a case that satisfying the division condition is that the virtual environment element includes an element configured with a reference mark, dividing the virtual environment element means obtaining, through division, the element configured with the reference mark and included in the virtual environment element. In other words, the sub-level environment element is the element configured with the reference mark and included in the virtual environment element.

A reference mark is preconfigured for a part of elements, so that whether the virtual environment element satisfies the division condition can be quickly determined by determining whether the virtual environment element includes an element configured with a reference mark. In this way, efficiency of determining whether the virtual environment element satisfies the division condition is high, and this helps improve efficiency of obtaining a virtual home material.

In an exemplary embodiment, that the virtual environment element satisfies the division condition may alternatively mean that the virtual environment element includes at least two separated environment elements. That two environment elements are separated means that any boundary of the two environment elements does not cross or coincide. In this case, dividing the virtual environment element means obtaining separated environment elements in the virtual environment element through division. In other words, sub-level environment elements are separated environment elements included in the virtual environment element.

In a case that the virtual environment element satisfies the division condition, the virtual home material includes the virtual environment element and the sub-level environment element. Because the sub-level environment element is an element obtained through division of the virtual environment element, the sub-level environment element appears twice in the virtual home material. However, one of the sub-level environment elements appears as a part of virtual environment elements, and cannot be used for separately arranging the virtual home; and the other one of the sub-level environment elements appears alone, and can be used for separately arranging the virtual home.

The process of determining the virtual home material based on the virtual environment element may be performed by the terminal, or may be performed by a server, which is not limited in some embodiments.

In a case that the process of determining the virtual home material based on the virtual environment element is performed by the terminal, the process of obtaining the virtual home material by the terminal includes: determining, in response to an operation of determining a target range, a virtual environment element within the target range in the virtual environment; determining whether the virtual environment element satisfies a division condition; and dividing the virtual environment element if the virtual environment element satisfies the division condition, to obtain a sub-level environment element, and using the virtual environment element and the sub-level environment element as virtual home materials; or if the virtual environment element does not satisfy the division condition, using the virtual environment element as the virtual home material.

In a case that the process of determining the virtual home material based on the virtual environment element is performed by a server, a process of obtaining the virtual home material by the terminal includes: The terminal sends, in response to an operation of determining a target range, coordinate information of the target range to the server. The server is configured to: determine, based on the coordinate information of the target range, a virtual environment element within the target range; determine whether the virtual environment element satisfies a division condition; and divide the virtual environment element if the virtual environment element satisfies the division condition, to obtain a sub-level environment element, and return the virtual environment element and the sub-level environment element as virtual home materials to the terminal; or return, if the virtual environment element does not satisfy the division condition, the virtual environment element as the virtual home material to the terminal. The terminal receives the virtual home material returned by the server.

In an exemplary embodiment, the terminal may further send coordinate information of a range covered by the range selection box to the server in real time. Each time the server receives the coordinate information, the server determines a virtual home material corresponding to the range based on the coordinate information, and returns, to the terminal, the virtual home material corresponding to the range. In this case, before obtaining the operation of determining the target range, the terminal may have already received and stored the virtual home material that corresponds to the target range and that is returned by the server. After the operation of determining the target range is obtained, the virtual home material corresponding to the target range is directly extracted from a storage.

In a possible implementation, after the virtual home material corresponding to the target range is obtained, the method further includes: displaying prompt information in response to an exit request, the prompt information being configured for prompting that the virtual home material has been stored in a material library.

For example, the display interface of the terminal may further display an exit control. The exit request may be initiated by the interaction object by triggering the exit control. If the interaction object triggers the exit control after the virtual home material corresponding to the target range is obtained, the terminal obtains a trigger operation on the exit control, and obtains the exit request in response to the trigger operation on the exit control.

For example, the exit request may alternatively be initiated by the interaction object by sending an exit voice instruction. If the interaction object sends the exit voice instruction after the virtual home material corresponding to the target range is obtained, the terminal obtains the exit voice instruction, and obtains the exit request in response to the exit voice instruction.

For example, the exit request may alternatively be initiated by the interaction object by triggering an exit shortcut key. If the interaction object triggers the exit shortcut key after the virtual home material corresponding to the target range is obtained, the terminal obtains a trigger operation on the exit shortcut key, and obtains the exit request in response to the trigger operation on the exit shortcut key. The exit shortcut key is a shortcut key bound with the exit request. The exit shortcut key may be set by the developer of the application, or may be set by the interaction object, which is not limited in some embodiments.

For example, the exit request may alternatively be initiated by the interaction object by using an exit gesture. If the terminal recognizes the exit gesture after the virtual home material corresponding to the target range is obtained, the terminal obtains the exit request. The exit gesture is a gesture bound with the exit request. The exit gesture may be set by the developer of the application, or may be set by the interaction object, which is not limited in some embodiments.

When the exit request is obtained, it is considered that a material obtaining mode may be exited. In this case, the prompt information is displayed, to prompt, by using the prompt information, the interaction object that the virtual home material has been stored in the material library of the interaction object. In this manner, the prompt information can be used for intuitively prompting that the interaction object has exited the material obtaining mode, and intuitively informing the interaction object of a storage location of the virtual home material. In this way, the interaction object can view stored virtual home materials more conveniently, and interaction experience of the interaction object can be improved, to increase a human-computer interaction rate.

In a possible implementation, the range selection box is hidden in response to the exit request. After the exit request is obtained, there is no may use the range selection box to continue to select a range. The range selection box is hidden in a timely, so that interference caused by the range selection box to a subsequent game process can be avoided. In this way, a display effect of the virtual environment can be improved, and visual experience of the interaction object can be improved, to increase a human-computer interaction rate.

In an exemplary embodiment, if the material obtaining control is hidden after the range selection box is displayed, the material obtaining control may be displayed again after the exit request is obtained, so that the interaction object can trigger the material obtaining control again when a virtual home material is needed to be obtained.

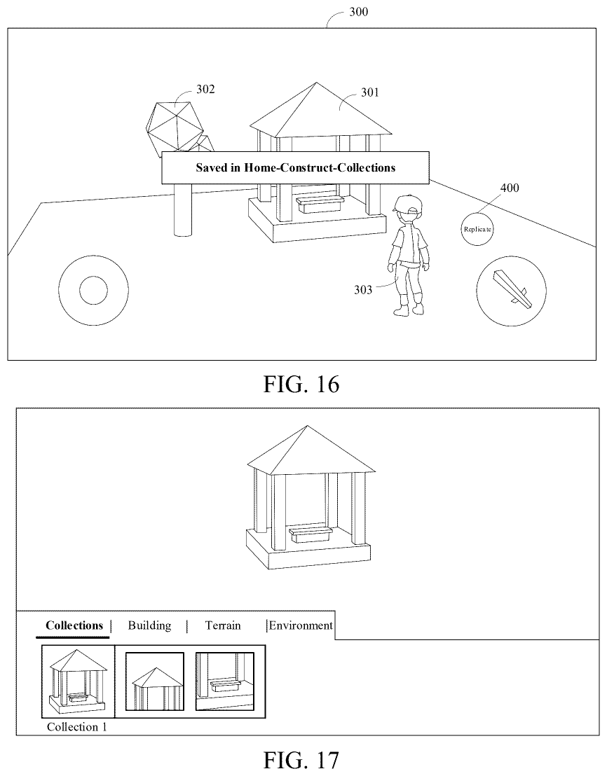

For example, referring to FIG. 5 to FIG. 14, after a material obtaining mode is entered, an exit control 411 is displayed on the display interface. After the terminal obtains a virtual home material by triggering the confirm control 410, the interaction object may trigger the exit control 411 (as shown in FIG. 15). After the interaction object triggers the exit control 411, the terminal obtains an exit request in response to a trigger operation on the exit control 411, and displays a display interface shown in FIG. 16 in response to the exit request. In FIG. 16, the range selection box 500 is hidden, the material obtaining control 400 and prompt information are displayed. Content of the prompt information is “saved in home-construction-collections”. “Home-construction-collections” means a location of the material library.

Before the prompt information is displayed, the obtained virtual home material may be first stored in the material library of the interaction object. A occasion of storing the virtual home material in the material library is not limited in some embodiments. For example, after the virtual home material is obtained, the virtual home material may be immediately stored in the material library. For example, after the exit request is obtained, the virtual home material may be stored in the material library.

In an exemplary embodiment, the interaction object may not perform an operation of determining any range, and directly initiates an exit request. In this case, the terminal hides the range selection box in response to the exit request, and does not display prompt information.

In a possible implementation, after the virtual home material is stored in the material library, the method further includes: displaying, in response to a viewing operation on the material library, an environment element included in the virtual home material; and arranging, in response to a selection operation on any environment element in the virtual home material, the virtual home by using the any environment element.

After the obtained virtual home material is stored in the material library, the interaction object may view the material library, and arrange the virtual home by using materials in the material library. After obtaining the viewing operation on the material library, the terminal displays the environment element included in the virtual home material. If the virtual home material satisfies the division condition, the environment element included in the virtual home material is the virtual environment element and the sub-level environment element. If the virtual home material does not satisfy the division condition, the environment element included in the virtual home material is the virtual environment element.

After the environment element included in the virtual home material is displayed, if the interaction object selects any environment element that is displayed, the any environment element is added to the virtual home, so that the virtual home can be arranged by using the any environment element.

For example, the viewing operation on the material library may be that the interaction object triggers an entry of the material library. For example, the entry of the material library may be a collections tab in the virtual home. For example, the selection operation on the any environment element may be an operation of dragging the any environment element to an arrangement area of the virtual home, or may be a double-click/double-tap operation on the any environment element.

The environment elements included in the virtual home material are displayed, so that the interaction object can flexibly select a needed environment element to arrange the virtual home. This helps improve flexibility in arranging a virtual home, and improve interest of the interaction object in arranging the virtual home, to increase a human-computer interaction rate.

For example, as shown in FIG. 17, after a viewing operation on the material library is obtained, three environment elements included in the virtual home material (denoted as “collection 1”) may be displayed. The three environment elements include an entire virtual environment element (a pavilion including a table) and two sub-level environment elements (respectively, a table and a pavilion not including a table) obtained through division of the virtual environment element. FIG. 17 shows an effect that the interaction object selects the entire virtual environment element (a pavilion including a table) and adds the entire virtual environment element to an arrangement area of the virtual home. It is clear that the interaction object may alternatively select any sub-level environment element (a table and a pavilion not including a table) and add the any sub-level environment element to the arrangement area of the virtual home.

After any environment element is added to the virtual home, in response to a selection operation on any environment element that has not been selected, the virtual home may further be arranged by using the any environment element that has not been selected.

Some embodiments provide a virtual home material obtaining method that is more random, more free, more convenient and open, and has a wider editing range, so that an interaction object can perform range selection, anytime and anywhere, on a landscape (a virtual environment element) that the interaction object expects to obtain. After the selection is completed, the landscape within the range is replicated, in other words, after the selection is completed, the landscape within the range is added to a material library of the virtual home as a virtual home material, so that the interaction object can randomly select a landscape that the interaction object expects to replicate to the virtual home for replication. In addition, an automatic division function is further provided, and a sub-level environment element is automatically obtained through division of the virtual environment element. For example, a pavilion includes furniture such as a stone table, a stone chair, and a guqin. The furniture is automatically classified into sub-level environment elements. The interaction object may select and place an entire scene of the virtual environment element to the virtual home, or decorate the virtual home by using the sub-level environment elements. In comparison with a method in a related technology, the method provided in some embodiments has a higher degree of freedom and is more convenient, and the interaction object does not may search a map for a replicable virtual environment element, so that materials in an entire open world can be better used. Searching a map is a process in which an interaction object controls a virtual object to continuously move in a map of a virtual environment.

The virtual home material obtaining method provided in some embodiments is be applicable to an open world, so that the interaction object can select, anytime and anywhere without a limitation of performing a replication operation at a position, a part of virtual environment elements that the interaction object expects to use for decoration of the virtual home. In addition, a highly convenient sub-level content division function is provided, so that the interaction object can decorate the home by using a complete set of landscape or a part of decorations in the landscape, to improve flexibility.

In some embodiments, a range selection box is provided for the interaction object to select a target range in a virtual environment, so as to obtain a virtual home material corresponding to the target range. Flexibility in selecting the target range is high. This helps improve flexibility in obtaining a virtual home material, improve a probability of obtaining a virtual home material that the interaction object expects to obtain, and improve intention of the interaction object to arrange a virtual home by using the obtained virtual home material, to increase a human-computer interaction rate.

In addition, a material obtaining request may be initiated by the interaction object by triggering a material obtaining control, and the material obtaining control is intuitive. This helps increase interest of the interaction object in initiating a material obtaining request, to increase a human-computer interaction rate.

The interaction object can quickly adjust the range selection box based on a target element, which is highly convenient. This helps improve efficiency of selecting the target range, and further improves efficiency of obtaining a virtual home material. The interaction object can randomly adjust the range selection box based on an adjustment control, and flexibility in adjusting the range selection box is high. This helps improve flexibility in obtaining a virtual home material. A plurality of adjustment controls are configured, so that ways of adjusting the range selection box for the interaction object can be enriched, flexibility in adjusting the range selection box by the interaction object can be further improved, and interest of the interaction object in selecting a target range by adjusting the range selection box can be improved, to increase a human-computer interaction rate.

A perspective switching function is provided, so that the interaction object can adjust the range selection box more accurately through observation from a plurality of perspectives. In this way, accuracy of a target range can be improved, and a degree of matching between an obtained virtual home material and an expectation of the interaction object can be further improved, to increase a human-computer interaction rate.

A virtual environment element satisfying a division condition is automatically divided. In addition, the entire virtual environment element and a sub-level environment element obtained through division are both used as virtual home materials, so that the interaction object can arrange the virtual home by using both the entire virtual environment element and the sub-level environment element obtained through division, to provide more material selection solutions for arranging a virtual home. This helps improve an arrangement effect of a virtual home, and increase a human-computer interaction rate. In addition, a reference mark is preconfigured for a part of elements, so that whether the virtual environment element satisfies the division condition can be quickly determined by determining whether the virtual environment element includes an element configured with a reference mark. In this way, efficiency of determining whether the virtual environment element satisfies the division condition is high, and this helps improve efficiency of obtaining a virtual home material.

After an exit request is obtained, the range selection box is hidden in a timely manner, so that interference caused by the range selection box to a subsequent game process can be avoided. In addition, prompt information is displayed, so that the interaction object is further intuitively informed of a storage location of a virtual home material. In this way, the interaction object can view stored virtual home materials more conveniently, and interaction experience of the interaction object can be improved, to increase a human-computer interaction rate.

Environment elements included in the virtual home material are displayed, so that the interaction object can flexibly select a needed environment element to arrange the virtual home. This helps improve flexibility in arranging a virtual home, and improve interest of the interaction object in arranging the virtual home, to increase a human-computer interaction rate.

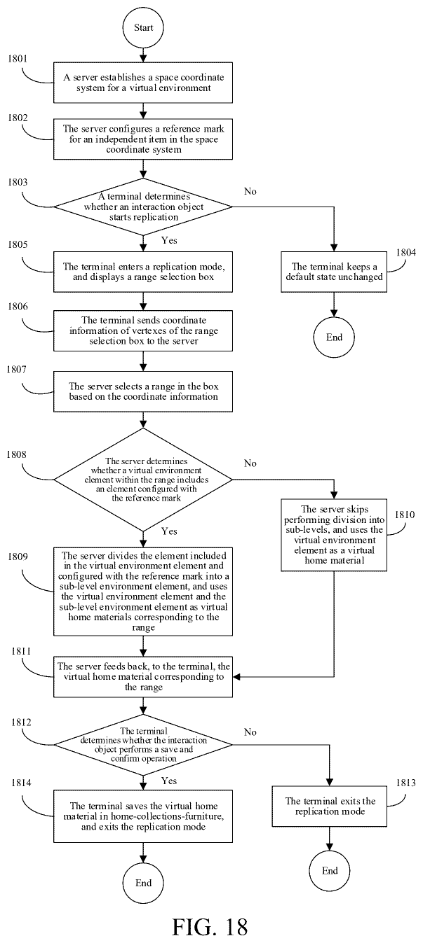

For example, a process of obtaining a virtual home material may be shown in FIG. 18. The process may include operation 1801 to operation 1814.

Operation 1801: A server establishes a space coordinate system for an entire virtual environment.

Grids with a rated spacing are set, and each grid point has a corresponding spatial coordinate value (x, y, z).

Operation 1802: The server performs dotting on an independent item in a space coordinate system. In other words, the server configures a reference mark for the independent item. For example, the independent item is denoted as A.

Operation 1803: A terminal determines whether an interaction object starts replication, in other words, whether an interaction object initiates a material obtaining request. If the interaction object does not start replication, in other words, does not initiate a material obtaining request, operation 1804 is performed. If the interaction object starts replication, in other words, initiates a material obtaining request, operation 1805 to operation 1814 are performed.

Operation 1804: The terminal keeps a default state unchanged. In other words, the terminal does not enter a replication mode (a material obtaining mode) and does not display a range selection box.

Operation 1805: The terminal enters the replication mode, and displays the range selection box.

After the interaction object enters the replication mode, a rectangular block (for example, the range selection box) is automatically generated at a fixed position in front of a virtual object controlled by the interaction object. For example, four vertexes below the rectangular block are on a lowest horizontal section at a current position.

Operation 1806: The terminal sends coordinate information of a vertexes of the range selection box to the server.

Operation 1807: The server finds a vertex position corresponding to the coordinate information in the space coordinate system, and selects a corresponding range in the virtual environment, to select the range in the box.

After displaying the range selection box, the terminal further may determine whether the interaction object performs enlargement, height adjustment, a moving operation, or the like on the range selection box. If the interaction object performs a corresponding operation on the range selection box, the range selection box is correspondingly deformed or moved, the terminal re-uploads coordinate information of the vertexes to the server, and the server re-determines and re-selects a corresponding range. If the interaction object does not perform an operation of adjusting the range selection box, the range selection box keeps the current position, and the server keeps the selected range.

In addition, after displaying the range selection box, the terminal further may determine whether the interaction object clicks/taps and selects an element (for example, a target element) configured with a reference mark. If the interaction object clicks/taps and selects the element configured with the reference mark (for example, the mark A) in the virtual environment, the range selection box automatically and adaptively selects the element configured with a reference mark. If the interaction object does not select the element configured with the reference mark (for example, the mark A) in the scene, no feedback is performed.

If the vertexes of the range selection box change, operation 1806 and operation 1807 may be repeatedly performed.

Operation 1808: The server determines whether a virtual environment element within the range includes an element configured with a reference mark (for example, the mark A). If the virtual environment element includes the element configured with the reference mark (for example, the mark A), after operation 1809 is performed, operation 1811 is performed. If the virtual environment element does not include the element configured with the reference mark (for example, the mark A), after operation 1810 is performed, operation 1811 is performed.

Operation 1809: The server divides the element included in the virtual environment element and configured with the reference mark into a sub-level environment element, and uses the virtual environment element and the sub-level environment element as virtual home materials corresponding to the range.

Operation 1810: The server skips performing division in to sub-levels, and uses the virtual environment element as a virtual home material.

Operation 1811: The server feeds back, to the terminal, the virtual home material corresponding to the range.

Operation 1812: The terminal determines whether the interaction object performs a save and confirm operation. If the interaction object performs no save and confirm operation, operation 1813 is performed. If the interaction object performs a save and confirm operation, operation 1814 is performed.

The performing a save and confirm operation means that an exit request is sent after a determining operation for a range is performed. The performing no save and confirm operation means that an exit request is directly sent in a case that no determining operation for any range is performed.

Operation 1813: The terminal exits the replication mode (for example, the material obtaining mode).

Operation 1814: The terminal saves the virtual home material in home-collections-furniture (for example, a material library), and exits the replication mode.

After the virtual home material in home-collections-furniture, if the interaction object enters the home to view collections, the terminal determines whether the collection is a group having a sub-level environment element. For a group having a sub-level environment element, the sub-level environment element is displayed, and for a group without a sub-level environment element, only main content (for example, a virtual environment element) is displayed.

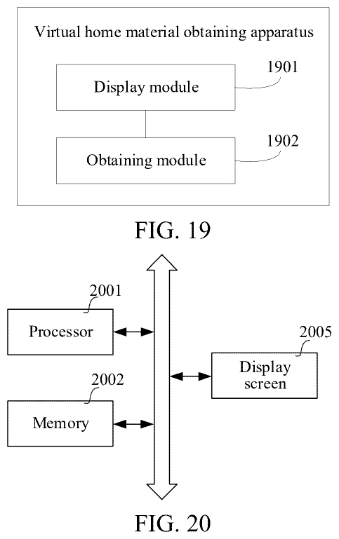

Refer to FIG. 19. Some embodiments provides a virtual home material obtaining apparatus. The apparatus includes:
a display module 1901, configured to display a virtual environment,
the display module 1901 being further configured to display a range selection box in the virtual environment; and
an obtaining module 1902, configured to obtain, in response to an operation of determining a target range, a virtual home material corresponding to the target range, the target range being a range selected from the virtual environment based on the range selection box, and the virtual home material being determined based on a virtual environment element within the target range in the virtual environment.

In a possible implementation, the display module 1901 is further configured to: move, in response to a selection operation on a target element in the virtual environment, the range selection box to a position with a center of the target element as a center, and adjust a size of the range selection box to a size that encloses the target element.

In a possible implementation, the range selection box corresponds to an adjustment control. The display module 1901 is further configured to adjust, in response to a trigger operation on the adjustment control, the range selection box in an adjustment manner corresponding to the adjustment control.

In a possible implementation, the adjustment control includes at least one of a translation control, a rotation control, or a size adjustment control, the size adjustment control including at least one of an overall-enlargement control, an overall-reduction control, or a dimension adjustment control, the dimension adjustment control including a sub-control corresponding to at least one dimension, and a sub-control corresponding to any dimension is configured to adjust a size of the any dimension of the range selection box.

In a possible implementation, the display module 1901 is further configured to switch, in response to a switching operation of switching a first perspective to a second perspective, a display effect of the virtual environment and the range selection box in the first perspective to a display effect in the second perspective, the first perspective and the second perspective being different perspectives for observing the virtual environment.

In a possible implementation, in a case that the virtual environment element satisfies a division condition, the virtual home material includes the virtual environment element and a sub-level environment element, and the sub-level environment element is obtained by dividing the virtual environment element.

In a possible implementation, that the virtual environment element satisfies a division condition includes: The virtual environment element includes an element configured with a reference mark; and the sub-level environment element is an element configured with the reference mark and included in the virtual environment element.

In a possible implementation, in a case that the virtual environment element does not satisfy the division condition, the virtual home material includes the virtual environment element, and the virtual home material does not include another environment element.

In a possible implementation, the display module 1901 is configured to display a material obtaining control.

The obtaining module 1902 is further configured to display the range selection box in the virtual environment in response to a trigger operation on the material obtaining control.

In a possible implementation, the display module 1901 is further configured to display prompt information in response to an exit request, the prompt information being configured for prompting that the virtual home material has been stored in a material library.

In a possible implementation, the display module 1901 is further configured to: display, in response to a viewing operation on the material library, an environment element included in the virtual home material; and arrange, in response to a selection operation on any environment element in the virtual home material, the virtual home by using the any environment element.

In a possible implementation, the display module 1901 is configured to hide the range selection box in response to the exit request.

For the apparatus provided in the foregoing embodiments, when implementing the functions of the apparatus, only division of the functional modules is described by using examples. During practical application, the functions are completed by different functional modules. In other words, an internal structure of the device is divided into different functional modules to complete all or some of the functions described above. In addition, the apparatus provided in the foregoing embodiments and the method embodiments fall within the same conception. For details of a implementation process and effects, reference is made to the method embodiments. Details are not described herein again.

FIG. 20 is a schematic diagram of a structure of a computer device according to some embodiments. The computer device may be a terminal, for example, a PC, a mobile phone, a smart phone, a PDA, a wearable device, a handheld portable game device, a PPC, a tablet computer, a smart in-vehicle infotainment, a smart television, a smart speaker, or an on-board terminal. The terminal may also be referred to as another name, for example, user equipment, a portable terminal, a laptop terminal, or a desktop terminal.

Generally, the terminal includes a processor 2001 and a memory 2002.

The processor 2001 may include one or more processing cores, for example, a 4-core processor or an 8-core processor. The processor 2001 may be implemented in at least one hardware form of a digital signal processor (DSP), a field-programmable gate array (FPGA), and a programmable logic array (PLA). The processor 2001 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 2001 may be integrated with a graphics processing unit (GPU). The GPU is configured to render and draw content that may be displayed on a display screen. In some embodiments, the processor 2001 may further include an artificial intelligence (AI) processor. The AI processor is configured to process computing operations related to machine learning.

The memory 2002 may include one or more computer-readable storage media. The computer-readable storage medium may be non-transient. The memory 2002 may further include a high-speed random access memory and a non-volatile memory, for example, one or more disk storage devices or flash storage devices. In some embodiments, the non-transient computer-readable storage medium in the memory 2002 is configured to store at least one instruction. The at least one instruction is executed by the processor 2001, to enable the terminal to implement the virtual home material obtaining method provided in some embodiments.

In some embodiments, the terminal may further include a display screen 2005.

The display screen 2005 is configured to display a user interface (UI). The UI may include a graph, text, an icon, a video, and any combination thereof. When the display screen 2005 is a touch display screen, the display screen 2005 further has a capability of collecting a touch signal on or above a surface of the display screen 2005. The touch signal may be input to the processor 2001 as a control signal for processing. In this case, the display screen 2005 may be further configured to provide a virtual button and/or a virtual keyboard that are/is also referred to as a soft button and/or a soft keyboard. In some embodiments, there may be one display screen 2005 disposed on a front panel of the terminal. In some other embodiments, there may be at least two display screens 2005 respectively disposed on different surfaces of the terminal or designed in a foldable shape. In some other embodiments, the display screen 2005 may be a flexible display screen disposed on a curved surface or a folded surface of the terminal. Even, the display screen 2005 may be further configured in a non-rectangular irregular pattern, for example, a special-shaped screen. The display screen 2005 may be prepared by using materials such as a liquid crystal display (LCD) or an organic light-emitting diode (OLED).

A person skilled in the art may understand that the structure shown in FIG. 20 does not constitute a limitation to the terminal, and the terminal may include more or fewer components than those shown in the figure, or some components may be combined, or a different component deployment may be used.

In an exemplary embodiment, a computer device is further provided. The computer device includes a processor and a memory, and the memory has at least one computer program stored therein. The at least one computer program is loaded and executed by one or more processors, to enable the computer device to implement any of the foregoing virtual home material obtaining method.

In an exemplary embodiment, a non-volatile computer-readable storage medium is provided. The non-volatile computer-readable storage medium has at least one computer program stored thereon. The at least one computer program is loaded and executed by a processor of a computer device, to enable a computer to implement any one of the foregoing virtual home material obtaining method.

In a possible implementation, the computer-readable storage medium may be a read-only memory (ROM), a random access memory (RAM), a compact disc read-only memory (CD-ROM), a magnetic tape, a floppy disk, an optical data storage device, and the like.

In an exemplary embodiment, a computer program or a computer program product is provided. The computer program or the computer program product includes computer instructions. The computer instructions are loaded and executed by a processor, to enable a computer to implement any one of the foregoing virtual home material obtaining method.

Information (including but not limited to user equipment information, users' personal information, and the like), data (including but not limited to data used for analysis, stored data, displayed data, and the like), and signals in this application are all authorized by users or fully authorized by all parties, and collection, use, and processing of related data may comply with relevant laws, regulations, and standards of relevant countries and regions. For example, the material obtaining request, the operation of determining the target range, and the like in this application are all obtained under full authorization.

The terms “first”, “second”, and the like in this application are intended to distinguish similar objects but do not necessarily indicate a order or sequence. Such used data is interchangeable where appropriate, so that some embodiments described here can be implemented in an order other than those illustrated or described here. The implementations described in the foregoing exemplary embodiments do not represent all implementations consistent with this application. On the contrary, the implementations are merely examples of apparatuses and methods that are consistent with some aspects of this application.

“A plurality of” mentioned in this specification means two or more. “And/or” describes an association relationship between associated objects and indicates that three relationships may exist. For example, A and/or B may indicate the following three cases: Only A exists, both A and B exist, and only B exists. The character “/” generally indicates an “or” relationship between the associated objects.

The foregoing descriptions are merely some embodiments, but are not intended to limit this application. Any modification, equivalent replacement, or improvement made within the principle of this application shall fall within the protection scope of this application.

What is claimed is:

1. A virtual home material obtaining method, performed by a computer device, and comprising:
displaying a virtual environment;
displaying a range selection interface in the virtual environment;
receiving a user input indicating a target range selected from the virtual environment based on the range selection interface;
obtaining a virtual home material corresponding to the target range, based on a virtual environment element in the target range.

2. The method according to claim 1, further comprising:
receiving a selection operation on a target element in the virtual environment; and
adjusting the range selection interface to center on the target element and resize to encompass the target element.

3. The method according to claim 1, further comprising:
providing one or more adjustment controls associated with the range selection interface; and
adjusting the range selection interface based on the one or more adjustment controls.

4. The method according to claim 3,
wherein the one or more adjustment controls include at least one of:
a translation control, a rotation control, or a size adjustment control,
wherein the size adjustment control includes at least one of:
an overall-enlargement control, an overall-reduction control, or a dimension adjustment control,
wherein the dimension adjustment control includes at least one sub-control corresponding to at least one dimension,
wherein the at least one sub-control is configured to adjust a dimension of the range selection interface.

5. The method according to claim 1, further comprising:
displaying the virtual environment and the range selection interface from a first perspective;
receiving a perspective switching operation;
switching to display the virtual environment and the range selection interface from a second perspective different from the first perspective.

6. The method according to claim 1,
based on the virtual environment element satisfying a division condition, generating the virtual home material to include the virtual environment element and at least one sub-level environment element,
wherein the at least one sub-level environment element is obtained by dividing the virtual environment element.

7. The method according to claim 6,
wherein the virtual environment element includes an element configured with a reference mark, and
the sub-level environment element is configured with the reference mark and is in the virtual environment element.

8. The method according to claim 1,
wherein, based on the virtual environment element not satisfying a division condition, the virtual home material includes the virtual environment element without any sub-level environment elements.

9. The method according to claim 1, further comprising:
displaying a material obtaining control; and
wherein displaying the range selection interface comprises:
displaying the range selection interface in the virtual environment based on a user activation on the material obtaining control.

10. The method according to claim 1, further comprising:
receiving an exit request after obtaining the virtual home material;
storing the virtual home material in a material library; and
displaying prompt information indicating that the virtual home material has been stored in the material library.

11. The method according to claim 10, further comprising:
receiving a viewing operation for the material library;
displaying at least one environment element in the stored virtual home material; and
arranging, in response to a selection operation on the at least one environment element, the virtual home.

12. The method according to any one of claim 10, further comprising:
hiding the range selection interface in response to the exit request.

13. A virtual home material obtaining apparatus, comprising:
at least one memory configured to store program code; and
at least one processor configured to read the program code and operate as instructed by the program code, the program code comprising:
environment code configured to cause at least one of the at least one processor to display a virtual environment;
interface code configured to cause at least one of the at least one processor to display a range selection interface in the virtual environment;
input code configured to cause at least one of the at least one processor to receive a user input indicating a target range selected from the virtual environment based on the range selection interface;
obtaining code configured to cause at least one of the at least one processor to obtain a virtual home material corresponding to the target range, based on a virtual environment element in the target range.

14. The apparatus according to claim 13, wherein the program code further comprises:
selection code configured to cause at least one of the at least one processor to receive a selection operation on a target element in the virtual environment; and
adjustment code configured to cause at least one of the at least one processor to adjust the range selection interface to center on the target element and resize to encompass the target element.

15. The apparatus according to claim 13, wherein the program code further comprises:
control code configured to cause at least one of the at least one processor to provide one or more adjustment controls associated with the range selection interface; and
wherein the adjustment code is further configured to cause at least one of the at least one processor to adjust the range selection interface based on the one or more adjustment controls.

16. The apparatus according to claim 15,
wherein the one or more adjustment controls include at least one of:
a translation control, a rotation control, or a size adjustment control,
wherein the size adjustment control includes at least one of:
an overall-enlargement control, an overall-reduction control, or a dimension adjustment control,
wherein the dimension adjustment control includes at least one sub-control corresponding to at least one dimension,
wherein the at least one sub-control is configured to adjust a dimension of the range selection interface.

17. The apparatus according to claim 13, wherein the program code further comprises:
perspective code configured to cause at least one of the at least one processor to display the virtual environment and the range selection interface from a first perspective;
switching code configured to cause at least one of the at least one processor to receive a perspective switching operation;
display code configured to cause at least one of the at least one processor to switch to display the virtual environment and the range selection interface from a second perspective different from the first perspective.

18. The apparatus according to claim 13,
wherein the obtaining code is further configured to cause at least one of the at least one processor to generate, based on the virtual environment element satisfying a division condition, the virtual home material to include the virtual environment element and at least one sub-level environment element,
wherein the at least one sub-level environment element is obtained by dividing the virtual environment element.

19. The apparatus according to claim 17,
wherein the virtual environment element includes an element configured with a reference mark, and
the sub-level environment element is configured with the reference mark and is in the virtual environment element.

20. A non-transitory computer-readable storage medium, storing computer code which, when executed by at least one processor, causes the at least one processor to at least:
display a virtual environment;
display a range selection interface in the virtual environment;
receive a user input indicating a target range selected from the virtual environment based on the range selection interface;
obtain a virtual home material corresponding to the target range, based on a virtual environment element in the target range.
